(19) United States
(12) Patent Application Publication
(10) Pub. No.: US 2008/0018289 A1
(43) Pub. Date: Jan. 24, 2008

(54) SINGLE-PHASE POSITION SENSORLESS PERMANENT MAGNET MOTOR CONTROL APPARATUS

(76) Inventors: Fumio Tajima, Hitachi (JP); Shigeru Kakugawa, Hitachi (JP); Masashi Kitamura, Mito (JP); Shoichi Kawamata, Hitachi (JP); Hiroshi Kanazawa, Hitachiota (JP); Takayuki Koyama, Hitachi (JP); Shoji Ohiwa, Saitama (JP); Osamu Sekiguchi, Ryugasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/780,382

(22) Filed: Jul. 19, 2007

(30) Foreign Application Priority Data
Jul. 21, 2006 (JP) 2006-198879
Jul. 21, 2006 (JP) 2006-198880

(51) Int. Cl. H02P 6/18

(52) U.S. Cl. 318/721

(57) ABSTRACT

A single-phase permanent magnet motor control apparatus, in particular, a low price, flat output torque, low vibration, low noise single-phase permanent magnet motor control apparatus, and a fan and pump using such a single-phase permanent magnet motor control apparatus are provided. In a single-phase permanent magnet motor control apparatus for driving a single-phase permanent magnet motor by using a DC power supply, a converter for converting DC to AC, and a control circuit for controlling the converter, a motor current measuring unit, a terminal voltage measuring unit, a correction unit for correcting an impedance drop in motor constants, and a calculation unit for finding an induced voltage to be obtained by control are included, and a polarity of a terminal voltage is determined on the basis of a value of the found induced voltage.

### BACKGROUND OF THE INVENTION

The present invention relates to a single-phase position sensorless permanent magnet motor control apparatus. In particular, the present invention provides a low vibration, low noise, small-sized, light weight, low-cost single-phase position sensorless permanent magnet motor control apparatus which runs and controls a single-phase permanent magnet motor and consequently which is suitable to mount on a vehicle such as an automobile.

The present invention relates to a single-phase permanent magnet motor control apparatus. In particular, the present invention relates to a low price, flat output torque, low vibration, low noise single-phase permanent magnet motor control apparatus, and a fan and a pump using such a single-phase permanent magnet motor control apparatus.

A single-phase permanent magnet motor control apparatus is used as a fan drive source.

As compared with an ordinary three-phase motor, the single-phase permanent magnet motor control apparatus has one set of windings (whereas three sets are included in the case of the three-phase motor). As for the conversion circuit as well, an H-bridge can be used. Therefore, the number of components becomes four (whereas six components are required in the case of the three-phase motor). Thus, the single-phase permanent magnet motor control apparatus has a great price merit. If a position detector is attached, only one hall element is required (whereas three hall elements are required in the case of the three-phase motor), resulting in a price merit as compared with the case of the three-phase motor.

On the other hand, in application such as fans where the starting torque is not large or the rising time is gentle, sensorless drive is conducted. As compared with the established sensorless drive of the three-phase motor, the sensorless drive of the single-phase permanent magnet motor becomes conversely complicated, resulting in a problem.

In addition, as compared with the three-phase motor, the single-phase permanent magnet motor has, in principle, a problem that torque generated by a current let flow through single-phase windings and magnetic flux of the permanent magnets generates two zero or negative torque regions per cycle in electric angle in at least the rotation direction. This problem is coped with by exercising control or contriving the shape of the stator core so as to change the gap length of the stator core in the circumference direction, make up for the zero or negative torque with cogging torque generated by the stator core and the permanent magnets, and thereby prevent negative torque from being generated.

As for the use, there is a tendency that applications to pumps mainly in automobiles increase besides the fans. Major reasons of the adoption and expansion of pump drive using an electric motor are that power saving control can be achieved by exercising motor control instead of pump drive using an engine as a measure for improving the fuel expenses or that pump drive using an engine is restricted by execution of idling stop. In this case, the low price is very important. In addition, in the case of the fan or pump, large start torque is not needed and the problem that the start torque is hard to obtain which is a major problem of the single-phase permanent magnet motor does not matter. Therefore, it is easy to adopt the single-phase permanent magnet motor.

A disclosure example of representative control of sensorless drive of the single-phase permanent magnet motor having the price merit is shown in JP-B-7-63232.

According to JP-B-7-63232, the position of the rotor (changeover point of applied voltage) is detected by providing an energization stop period near a changeover point between positive and negative parts of an induced voltage in the single-phase permanent magnet motor, generating an induced voltage between windings, and discriminating whether the induced voltage is positive or negative.

In addition, a single-phase permanent magnet motor control apparatus is used as the fan drive source because of its low price. The single-phase permanent magnet motor has, in principle, a problem that torque generated by a current let flow through single-phase windings and magnetic flux of the permanent magnets generates two zero or negative torque regions per cycle in electric angle in at least the rotation direction. This problem is coped with by exercising control or contriving the shape of the stator core so as to change the gap length of the stator core in the circumference direction, make up for the zero or negative torque with cogging torque generated by the stator core and the permanent magnets, and thereby prevent negative torque from being generated.

As compared with an ordinary three-phase motor, the single-phase permanent magnet motor control apparatus has one set of windings (whereas three sets are included in the case of the three-phase motor). As for the conversion circuit as well, an H-bridge can be used. Therefore, the number of components becomes four (whereas six components are required in the case of the three-phase motor). Thus, the single-phase permanent magnet motor control apparatus has a great price merit. If a position detector is attached, only one hall element is required (whereas three hall elements are required in the case of the three-phase motor), resulting in a price merit as compared with the case of the three-phase motor. On the other hand, there are drawbacks that the output torque at the time of operation is hard to become flat and vibration noise is apt to occur because of restrictions described above.

As for the use, there is a tendency that applications to pumps mainly in automobiles increase besides the fans. Major reasons of the adoption and expansion of pump drive using an electric motor are that power saving control can be achieved by exercising motor control instead of pump drive using an engine as a measure for improving the fuel expenses or that pump drive using an engine is restricted by execution of idling stop. In this case, the low price is very important. In addition, in the case of the fan or pump, large start torque is not needed and the problem that the start torque is hard to obtain which is a major drawback of the single-phase permanent magnet motor does not matter. Therefore, it is easy to adopt the single-phase permanent magnet motor.

A disclosure example of representative control in the single-phase permanent magnet motor is shown in JP-A-2004-88870. In the example disclosed in JP-A-2004-88870, it is attempted to reduce torque ripple by placing restrictions in two places where the current becomes large in half electrical cycle of the motor in order to reduce the torque ripple of the single-phase permanent magnet motor.

### SUMMARY OF THE INVENTION

According to JP-B-7-63232, the position of the rotor is detected by providing an energization stop period near a changeover point between positive and negative parts of an induced voltage in the single-phase permanent magnet motor, generating an induced voltage between windings, and discriminating whether the induced voltage is positive or negative. As a result, the polarity of the applied voltage capable of generating positive torque can always be confirmed, and consequently sensorless drive can be conducted. Basically in this scheme, however, a quiescent period of a current for outputting an induced voltage on the windings is provided. Therefore, there is a fear that efficiency drop and an increase in pulsating torque might be caused, resulting in a motor yielding large noise and vibration.

Therefore, an object of the present invention is to provide a low noise, low vibration single-phase permanent magnet motor control apparatus that eliminates the problems of the conventional art described heretofore and that is little in efficiency falling and a fan or pump using the single-phase permanent magnet motor control apparatus.

The example described in JP-A-2004-88870 brings about an effect that the torque ripple is reduced to some extent with a simple configuration.

When the number of revolutions has changed, when the load has changed, or when the temperature has changed, however, it cannot be coped with sufficiently and there is a fear that torque ripple might be generated resulting in vibration and noise.

Therefore, another object of the present invention is to solve the problems of the conventional art described heretofore, cope with load variation to some extent, reduce the torque ripple, and thereby provide a low vibration, low noise, low cost single-phase permanent magnet motor control apparatus and a fan and a pump using the single-phase permanent magnet motor control apparatus.

An aspect of the present invention provides a single-phase position sensorless permanent magnet control apparatus for controlling a power converter which drives a single-phase permanent magnet motor includes a motor current measuring unit, the single-phase position sensorless permanent magnet control apparatus providing a terminal voltage measuring unit, a correction unit for correcting an impedance drop in motor constants, and a calculation unit for finding an induced voltage to be obtained by control, wherein a polarity of a terminal voltage is determined on the basis of a value of the found induced voltage.

As a result, it is possible to provide a low torque ripple, low noise, low vibration, high efficiency single-phase position sensorless permanent magnet motor.

Another aspect of the present invention provides a single-phase permanent magnet motor control apparatus for controlling a power converter to drive a single-phase permanent magnet motor which includes a rotor having permanent magnets and a stator having single-phase windings and which generates cogging torque by magnetic action between the rotor and the stator, wherein the single-phase permanent magnet motor control apparatus comprises cogging torque and induced voltage waveform information of the single-phase permanent magnet motor.

As a result, it is possible to provide a low vibration, low noise, low cost single-phase permanent magnet motor control apparatus, and a fan and a pump using the single-phase permanent magnet motor control apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 shows a single-phase position sensorless permanent magnet motor drive circuit in an embodiment according to the present invention;

FIGS. 2A to 2F show operation explanation diagrams of the embodiment according to the present invention;

FIGS. 3A to 3D show operation explanation diagrams of another embodiment according to the present invention;

FIG. 4 shows a single-phase permanent magnet motor drive circuit in still another embodiment according to the present invention;

FIG. 5 shows details of a principal part in the still another embodiment according to the present invention;

FIGS. 6A to 6H show operation explanation diagrams of the still another embodiment according to the present invention;

FIG. 7 shows details of a principal part in yet another embodiment according to the present invention; and

FIGS. 8A to 8I show operation explanation diagrams of the still another embodiment according to the present invention.

### DETAILED DESCRIPTION OF THE EMBODIMENTS

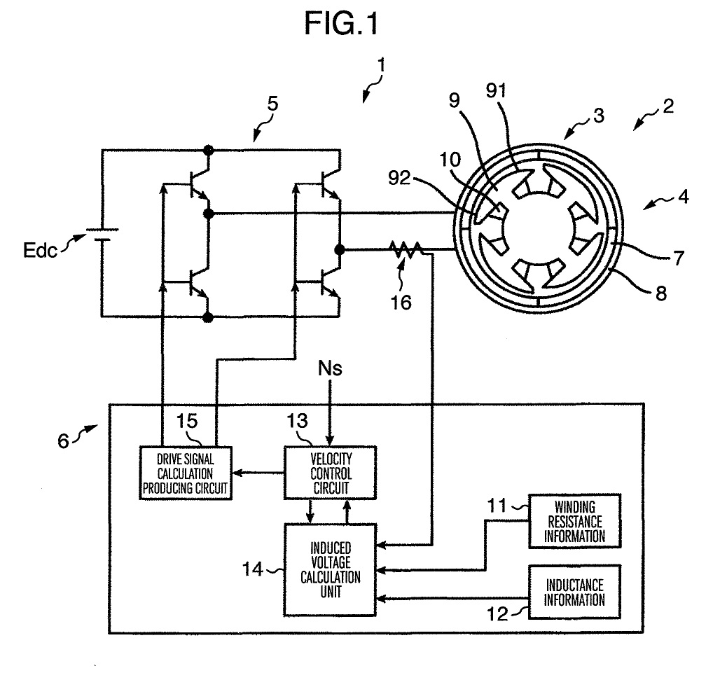

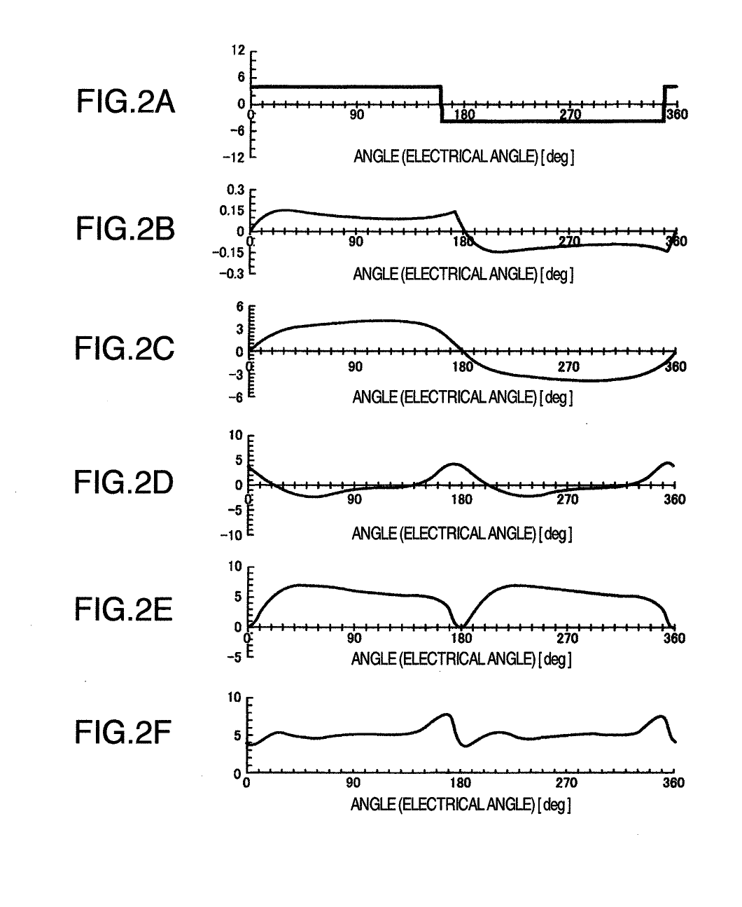

FIG. 1 shows a configuration of a single-phase position sensorless permanent magnet motor control apparatus according to an embodiment of the present invention. FIGS. 2A to 2F show its operation explanation diagrams.

In FIG. 1, a single-phase position sensorless permanent magnet motor control apparatus 1 includes a single-phase permanent magnet motor 2, a conversion circuit 5 which functions to supply AC power from a DC power supply Edc to the single-phase permanent magnet motor 2, and a control circuit 6 which controls an output current of the conversion circuit 5.

The single-phase permanent magnet motor 2 includes a stator 3 and a rotor 4. In the ensuing description, it is supposed that the motor is the so-called outer rotor type motor in which the stator 3 is disposed on an inner circumference and the rotor 4 is disposed on an outer circumference. However, similar description holds true of the inner rotor type motor or other motors. In the shown example, the number of poles of the permanent magnets in the rotor 4 is four. However, the effects of the present invention do not depend upon the number of poles.

In FIG. 1, the stator 3 includes a stator core 9, stator windings 10 wound around the stator core 9, and its supporting device (not illustrated). Typically, the stator core 9 is formed by stamping out thin silicon steel plates and laminating them. However, the stator core 9 may be formed of dust core. As illustrated, the number of salient poles is four, and it is made equal to the number four of permanent magnets 7 in the rotor 4. Four stator windings 10 are connected in series and connected to the conversion circuit 5 as illustrated.

The rotor 4 includes permanent magnets 7 and a rotor core 8 disposed around the permanent magnets 7 to constitute a magnetic circuit for the permanent magnets 7 and fulfill a role of mechanical coupling to an output shaft (not illustrated). As for the magnets, ferrite rubber magnets or plastic magnets are typically used because of their low prices.

In FIG. 1, the gap face of the stator core 9 is selected with respect to the gap between the rotor 4 and the stator 3 as follows: the surface of the stator core 9 in the rotation direction is determined as indicated by 92 so as to have a nearly constant small gap length, whereas the surface of the stator core 9 in the anti-rotation direction (herein, the rotor 4 is supposed to rotate in the counterclockwise direction) is determined as indicated by 91 so as to have a gradually increasing gap length. In principle, in the single-phase permanent magnet motor, torque generated by a current let flow through single-phase windings and magnetic flux of the permanent magnets generates two zero or negative torque regions per cycle in electric angle in at least the rotation direction. By taking the above-described shape, cogging torque that can make up for the zero or negative torque can be generated effectively, resulting in low vibration and low noise.

In a typical single-phase permanent magnet motor, a position detector is disposed on the stator 3 so as to be located near the shaft end of each of the permanent magnets 7 in the rotor 4. (Typically, a hall element is used to detect the magnetic flux of the permanent magnet 7.) The position detector functions to detect the position of the permanent magnet 7 and let flow an effective current through the single-phase permanent magnet motor 2 via the conversion circuit 5. In applications such as automobiles, however, the use environment is high in temperature and hall elements cannot be used in some cases. If it is difficult to dispose the position detection elements because of circuit mounting, the senseless drive scheme described in the disclosure example is conceivable.

In accordance with an aspect of the present invention, a control circuit 6 includes an induced voltage calculation unit 14 for calculating an induced voltage of the single-phase permanent magnet motor 2 on the basis of information of a current sensor 16 and previously stored winding resistance information 11 and inductance information 12 of the stator windings 10, a velocity control circuit 13, and a drive signal computing and producing circuit 15 for synthesizing signals from the velocity control circuit 13 and so on. In accordance with the present invention, the position of the rotor is determined and timing of applied voltage is determined on the basis of information obtained by the induced voltage calculation unit 14. As a result, continuous energization is possible and single-phase sensorless operation with little torque ripple is made possible. Therefore, magnetic pole position detectors are made unnecessary and sensorless operation is made possible.

Hereafter, operation in the present invention will be described with reference to FIGS. 2A to 2F.

FIGS. 2A to 2F are operation explanation diagrams of the above-described control in the present invention.

FIG. 2A shows a terminal voltage Et(θ) of the motor. The magnitude of the terminal voltage is regulated by PWM (Pulse Width Modulation) or the like. PWM between positive and negative half cycles is typically made constant. By the way, it is also possible to make the terminal voltage lead or lag behind an induced voltage shown in FIG. 2B by causing a delay of a fixed time from a zero crossing point. It is also possible to have the value of the terminal voltage Et(θ) in a microcomputer.

FIG. 2C shows the induced voltage as a function of the rotation electrical angle.

The induced voltage has a feature that the waveform is bilaterally asymmetric because of the shape of the stator core on the gap face. The induced voltage calculation unit 14 calculates an induced voltage E0(θ) according to the following equation by using information of the terminal voltage Et(θ), a current i(θ) of a current sensor, winding resistance r and winding inductance L.

$$EO ( θ ) = Et ( θ ) - ( r + L ) \frac{d i ( θ )}{d t} \qquad ( 1 )$$

where

Et(θ) is the terminal voltage shown in FIG. 2A,

r is winding resistance,

L is winding inductance, and

i(θ) is a current value measured by the current sensor 16.

FIG. 2B shows the current i(θ) which is taken in from the current sensor 16.

FIG. 2D shows cogging torque Tcog(θ). This is generated by the shape of the gap face of the stator core, the size of the slit between stator salient poles, and magnetic action with the magnetic flux distribution of the permanent magnets.

FIG. 2E shows electromagnetic torque Tw(θ) which is generated by the magnetic flux (induced voltage) generated by the permanent magnet and a current which flows through the stator windings. The electromagnetic torque Tw(θ) can be calculated by using the following equation.

$$Tw ( θ ) = \frac{EO ( θ ) I ( θ )}{ω} \qquad ( 2 )$$

where

ω represents information of rotation angular velocity,

E0(θ) represents induced voltage information for an angle θ at each velocity ω, and

I(θ) represents current information obtained by the current sensor.

FIG. 2F shows total torque Tt(θ). The total torque Tt(θ) can be calculated by using the following equation as the sum of the electromagnetic torque Tw(θ) and the cogging torque Tcog(θ).

Tt(θ)=Tcog(θ)+Tw(θ) (3)

where Tcog(θ) represents the cogging torque for the rotation angle.

In accordance with the present invention, the single-phase permanent magnet motor shown in FIG. 1 is typically controlled by the velocity control circuit 13 to follow a velocity command Ns. For exercising the velocity control, velocity information of the single-phase permanent magnet motor becomes necessary. On the basis of induced voltage information obtained by the induced voltage calculation unit 14, velocity feedback information is calculated from a period of one cycle in electrical angle. Constant velocity control is exercised by utilizing the velocity feedback information and using proportional integral control according to the velocity error as occasion demands. The motor can be controlled to have the velocity Ns by the control described heretofore.

In accordance with the present invention, the positive-negative changeover of the terminal voltage Et(θ) is conducted on the basis of the induced voltage information obtained by the induced voltage calculation unit 14 according to the equation (1). For example, the terminal voltage is changed over from positive to negative when the induced voltage falls from a highest positive part and reaches a predetermined value or less. The terminal voltage thus controlled is shown in FIG. 2A.

The voltage is controlled to become constant until the next changeover point. As occasion demands, however, it is also possible to provide the rising part or the falling part with a voltage change near the changeover point. The current can be controlled continuously by such control.

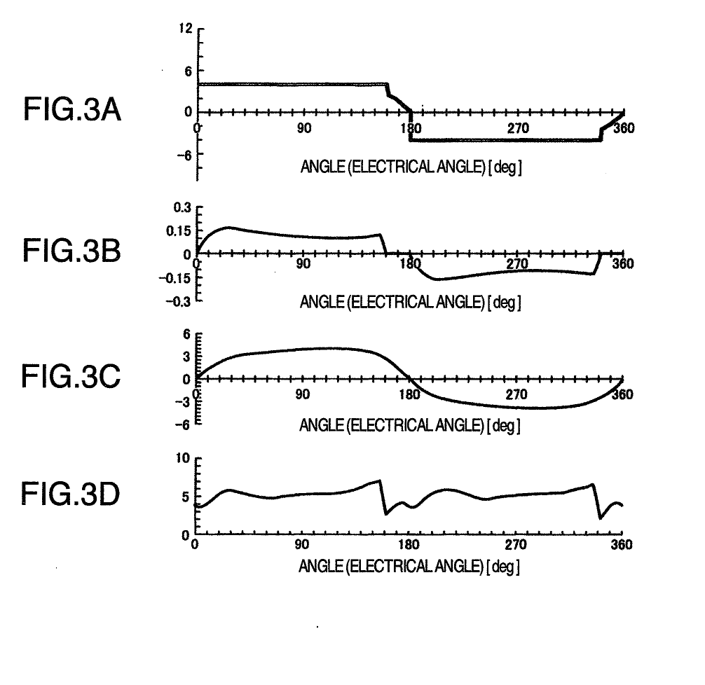

FIGS. 3A to 3D are operation explanation diagrams of another embodiment according to the present invention.

Since the current quiescent period for detecting the terminal voltage is provided during half cycle, a steep torque change occurs in the output torque. Furthermore, since the current stop period is provided, it becomes necessary to increase the current in other energization periods, resulting in a lowered efficiency.

As a result of the control described heretofore, it is possible to provide a low torque ripple, low noise, low vibration, high efficiency single-phase position permanent magnet motor.

In this way, the present invention provides a single-phase permanent magnet motor control apparatus for driving a single-phase permanent magnet motor by using a DC power supply, a converter for converting DC to AC, and a control circuit for controlling the converter, wherein a motor current measuring unit, a terminal voltage measuring unit, a correction unit for correcting an impedance drop in motor constants, and a calculation unit for finding an induced voltage to be obtained by control are included, and a polarity of a terminal voltage is determined on the basis of a value of the found induced voltage. As compared with an ordinary three-phase motor, therefore, only one set of windings and one hall element are required as shown in FIG. 1 (whereas three sets are required in the case of the three-phase motor). As for the conversion circuit as well, an H-bridge can be used. Therefore, the number of components becomes four, resulting in a great price merit. On the other hand, owing to the above-described control, the operation torque can be flattened and a low noise, low vibration permanent magnet motor control apparatus that compares favorably with the three-phase motor can be provided.

By using the single-phase permanent magnet motor control apparatus in an electromotive fan and electromotive pump, it is possible to provide a low price, small-sized, light weight, low noise, low vibration electromotive fan and electromotive pump with a single configuration. (For example, when the fan and pump are disposed in a passenger room of a vehicle, the low noise and low price form powerful weapons.)

Description has been given heretofore with a mind to a system using a microcomputer as the control circuit 6. However, it is possible to implement a single-phase position sensorless permanent magnet motor control apparatus having the control circuit 6 which includes the induced voltage calculation unit 14, even if the control circuit 6 is constituted by using a discrete circuit including amplifiers, resistors and capacitors. In this case, the single-phase position sensorless permanent magnet motor control apparatus can be implemented with a more inexpensive configuration.

At the time of start, there is no information of induced voltage and the voltage energizing method is unknown. However, a mechanism for letting flow a current through the stator windings is included. As a result, stable start can be made possible by utilizing polarity discrimination for discriminating a current direction in which the rotor can output positive torque.

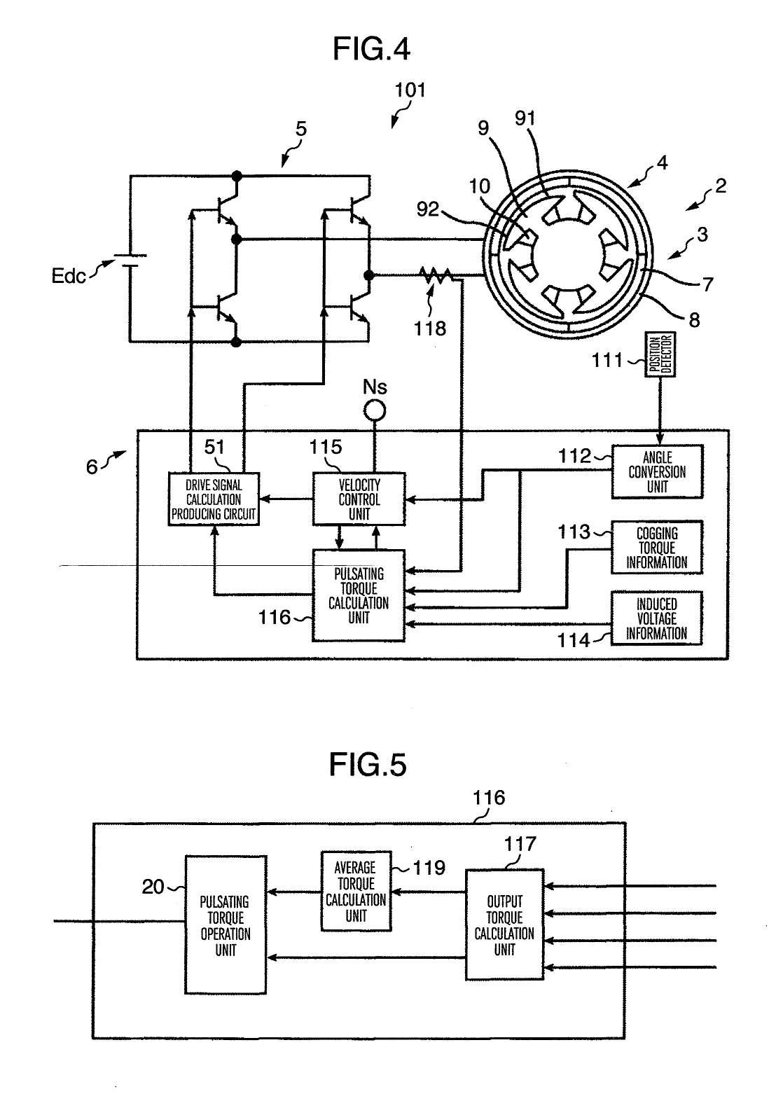

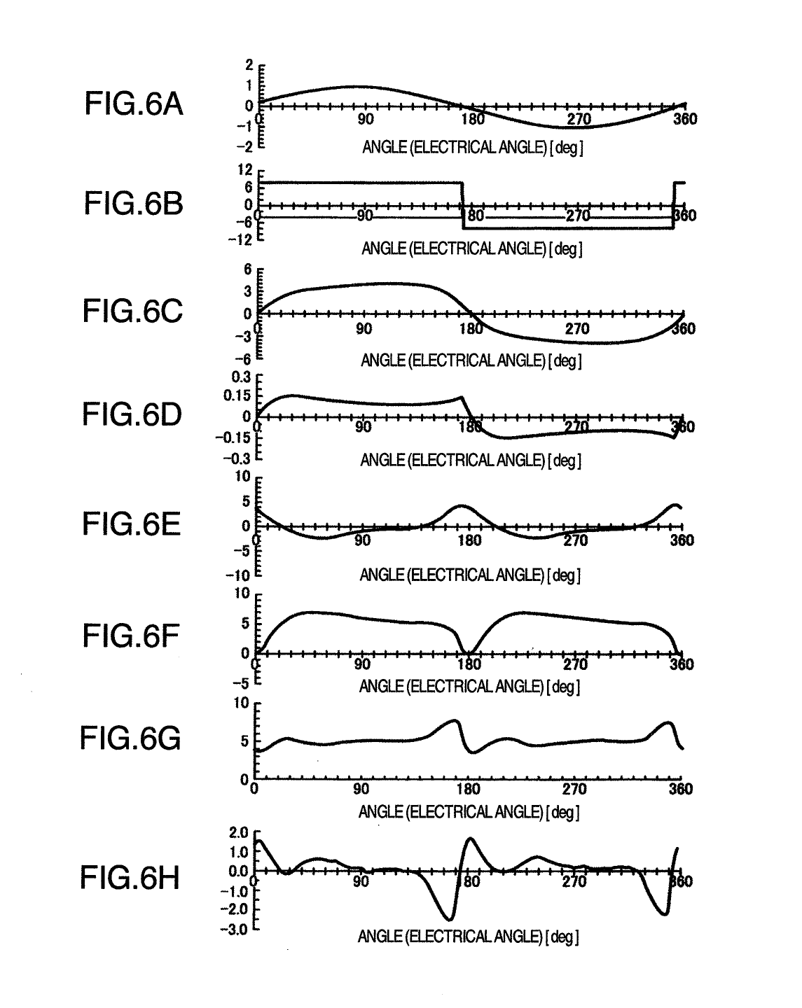

FIG. 4 shows a configuration of a single-phase permanent magnet motor control apparatus according to still another embodiment of the present invention. FIG. 5 shows details of its principal part. FIGS. 6A to 6H show its operation explanation diagrams.

In FIG. 4, a single-phase permanent magnet motor control apparatus 101 includes a single-phase permanent magnet motor 2, a conversion circuit 5 which functions to supply AC power from a DC power supply Edc to the single-phase permanent magnet motor 2, and a control circuit 6 which controls an output current of the conversion circuit 5.

The single-phase permanent magnet motor 2 includes a stator 3 and a rotor 4. In the ensuing description, it is supposed that the motor is the so-called outer rotor type motor in which the stator 3 is disposed on an inner circumference and the rotor 4 is disposed on an outer circumference. However, similar description holds true of the inner rotor type motor or other motors. In the shown example, the number of poles of the permanent magnets in the rotor 4 is four. However, the effects of the present invention do not depend upon the number of poles.

In FIG. 4, the stator 3 includes a stator core 9, stator windings 10 wound around the stator core 9, and its supporting device (not illustrated). Typically, the stator core 9 is formed by stamping out thin silicon steel plates and laminating them. However, the stator core 9 may be formed of dust core. As illustrated, the number of salient poles is four, and it is made equal to the number four of permanent magnets 7 in the rotor 4. Four stator windings 10 are connected in series and connected to the conversion circuit 5 as illustrated.

The rotor 4 includes permanent magnets 7 and a rotor core 8 disposed around the permanent magnets 7 to constitute a magnetic circuit for the permanent magnets 7 and fulfill a role of mechanical coupling to an output shaft (not illustrated). As for the magnets, ferrite rubber magnets or plastic magnets are typically used because of their low prices.

In FIG. 4, the gap face of the stator core 9 is selected to take a shape so that the gap between the rotor 4 and the stator 3 will become nearly constant in the rotation direction and the gap will gradually increase in the anti-rotation direction (herein, the rotor 4 is supposed to rotate in the counterclockwise direction). In particular, the gap face of the stator core 9 is determined so as to have a large gap length as indicated by 91 in the anti-rotation direction of the stator core 9 and have a nearly constant small gap length as indicated by 92 in the rotation direction. In principle, in the single-phase permanent magnet motor, torque generated by a current let flow through single-phase windings and magnetic flux of the permanent magnets generates two zero or negative torque regions per cycle in electric angle in at least the rotation direction. By taking the above-described shape, cogging torque that can make up for the zero or negative torque can be generated effectively, resulting in low vibration and low noise.

A position detector 111 is disposed on the stator 3 so as to be located near the shaft end of each of the permanent magnets 7 in the rotor 4. (Typically, a hall element is used to detect the magnetic flux of the permanent magnet 7.) The position detector 111 functions to detect the position of the permanent magnet 7 and let flow an effective current through the single-phase permanent magnet motor 2 via the conversion circuit 5. A current sensor 18 is included in the stator windings 10 of the single-phase permanent magnet motor or the conversion circuit 5. The current let flow through the stator windings 10 is always monitored by the current sensor 18.

The control circuit 6 controls the conversion circuit 5 which supplies power to the single-phase permanent motor, on the basis of information of the position detector 111 and a current sensor 118, and previously stored cogging torque information 113 and induced voltage information 114.

An angle conversion unit 112 is a calculation unit for estimating an electric angle θ of the rotor 4 on the basis of the information of the position detector 111. The angle conversion unit 112 can calculate the average velocity of the rotor 4 on the basis of the period of the positive-negative changeover of an output signal of the position detector 111, and calculate and estimate the angle of the rotor on the basis of time elapse in the control period. Furthermore, the positive-negative energization of the conversion circuit 5 is determined by positive-negative information of the position detector 111.

FIG. 5 shows details of a principal part of the embodiment according to the present invention. A pulsating torque calculation unit 116 includes an output torque calculation unit 117 for calculating output torque on the basis of an output of the current sensor 118, an output of the angle conversion unit 112, the cogging torque information 113 and the induced voltage information 114, an average torque calculation unit 119 for calculating an average value of an output of the output torque calculation unit 117, and a pulsating torque operation unit 20.

Hereafter, a method for calculating the pulsating torque will be described in detail.

Electromagnetic torque Tw(θ) which is generated by the magnetic flux generated by the permanent magnet and a current which flows through the stator windings can be represented by using the following equation.

$$Tw ( θ ) = \frac{EO ( θ ) I ( θ )}{ω} \qquad ( 4 )$$

where

ω represents information of rotation angular velocity,

E0(θ) represents induced voltage information for an angle θ at each velocity ω, and

I(θ) represents current information obtained by the current sensor.

Therefore, total torque Tt(θ) generated by the single-phase permanent magnet motor is represented by the following equation.

Tt(θ)=Tcog(θ)+Tw(θ) (5)

### Here, Tcog(θ) represents cogging torque for the rotation angle.

On the other hand, average torque Tav can be calculated according to the following equation by finding an average of the total torque Tt(θ) over one cycle of electrical angle (which may be half a cycle as occasion demands).

$$Tav = \frac{2}{π} {\int }_{- π}^{π} Tt ( θ ) d θ \qquad ( 6 )$$

Therefore, pulsating torque Tac(θ) can be represented by the following equation.

Tac(θ)=Tt(θ)−Tav (7)

In FIG. 4, the single-phase permanent magnet motor is typically controlled by a velocity control unit 115 to follow a velocity command Ns. As described above, control is exercised by utilizing the proportional integral control or the like as occasion demands, on the basis of velocity feedback information calculated from the period of one cycle of electrical angle of the position detector 111. On the other hand, one cycle of the position detector 111 is divided finely to produce a correction signal on the basis of pulsating torque information calculated by the pulsating torque calculation unit 116. Correction signals produced by the velocity control unit 115 and the pulsating torque calculation unit 116 are combined by a drive signal calculation producing circuit 51 to control the conversion circuit 5. As a result, it is possible to flatten the output torque of the single-phase permanent magnet motor by exercising correction control.

FIGS. 6A to 6H show operation explanation diagrams of the above-described control according to the present invention.

FIG. 6A shows an output signal of the position detector 111. It is also possible to previously make the output signal lead the induced voltage shown in FIG. 6C. Velocity information of the permanent magnet rotor can be calculated on the basis of the period of the signal over a half cycle or one cycle of the output signal of the position detector 111.

FIG. 6B is a terminal voltage of the motor. Basically, a positive voltage signal is applied to a zero crossing point from negative to positive of position detector. The voltage height is regulated by the PWM (Pulse Width Modulation) or the like. It is also possible to make the terminal voltage of the motor lead or lag behind the induced voltage shown in FIG. 6C by providing a delay from the zero crossing point by a predetermined time.

FIG. 6C shows induced voltage information as a function of the rotation electrical angle. Typically, an induced voltage constant obtained by dividing the induced voltage by the rotation velocity is stored. The rotation velocity can be converted to the induced voltage by multiplying the rotation velocity by the induced voltage constant.

FIG. 6D shows current information taken in from the current sensor 118. The current information is successively measured and stored in the memory.

FIG. 6E shows cogging torque information as a function of the rotation electrical angle. The cogging torque information is previously measured and stored in the memory.

FIG. 6F shows electromagnetic torque Tw(θ) which is generated by the magnetic flux (induced voltage) generated by the permanent magnet and a current which flows through the stator windings. The electromagnetic torque Tw(θ) can be calculated by using the equation (4).

FIG. 6G shows total torque. The total torque is the sum of the torque Tw(θ) and the cogging torque as indicated by the equation (5).

FIG. 6H shows pulsating torque, and it is calculated by using the equations (6) and (7).

The drive signal calculation producing circuit 51 combines an output of the velocity control unit 115 and an output of the pulsating torque calculation unit 116 to produce a signal for controlling the conversion circuit 5. As a result of the control heretofore described, torque ripple in FIG. 6G is corrected and a single-phase permanent magnet motor control apparatus with little torque ripple can be provided.

The above-described control is control of the fan and pump. The response frequency of the control is as low as several Hz. Therefore, control is exercised stably.

It is also possible to make the period of the velocity control equal to one electric cycle and conduct pulsating torque correction at an integer times the period. Furthermore, it is also possible to stop the control at the time of transition in largely changing the velocity command Ns signal as occasion demands.

As compared with an ordinary three-phase motor, only one set of windings and one hall element are required in the single-phase permanent magnet motor as shown in FIG. 4 (whereas three sets are required in the case of the three-phase motor). As for the conversion circuit as well, an H-bridge can be used. Therefore, the number of components also becomes four, resulting in a great price merit. On the other hand, owing to the above-described control, the operation torque can be flattened and a low noise, low vibration permanent magnet motor control apparatus that compares favorably with the three-phase motor can be provided.

In the configuration heretofore described, the cogging torque information 113 and the induced voltage information 114 are information that is proportional to square of the gap magnetic flux density or proportional to the gap magnetic flux density. The gap magnetic flux density is information that is proportional to the temperature. If, for example, a temperature sensor is provided in the single-phase permanent magnet motor control apparatus and the cogging torque information 113 and the induced voltage information 114 are corrected thereby, therefore, control with better precision can be exercised.

Furthermore, control with high precision is made possible by exercising the velocity control at half periods of electrical angle and dividing the period into a plurality of parts to exercise pulsating torque correction control.

Considering precisions of constants and their dependence upon the temperature as to the pulsating torque correction control, it is possible to select the case where stable control can be achieved when only proportional control is exercised although a larger deviation remains as compared with zero deviation control using integral control.

It is possible to provide a low price, small-sized, light weight, low noise, low vibration electromotive fan and electromotive pump with a simple configuration by adopting the single-phase permanent magnet motor control apparatus in the electromotive fan and electromotive pump.

Yet another embodiment of the present invention will now be described.

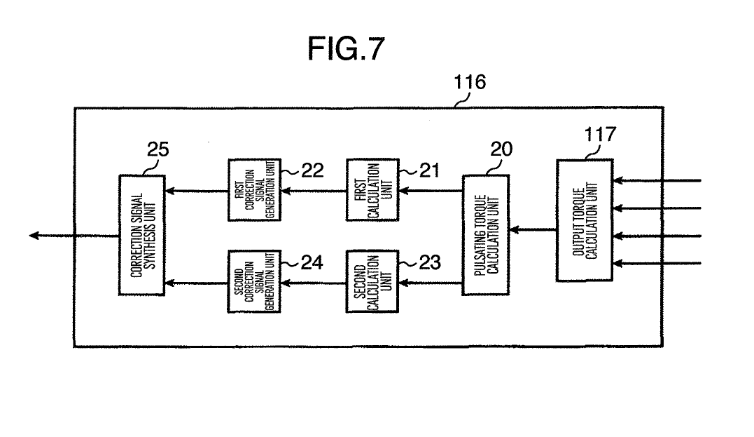

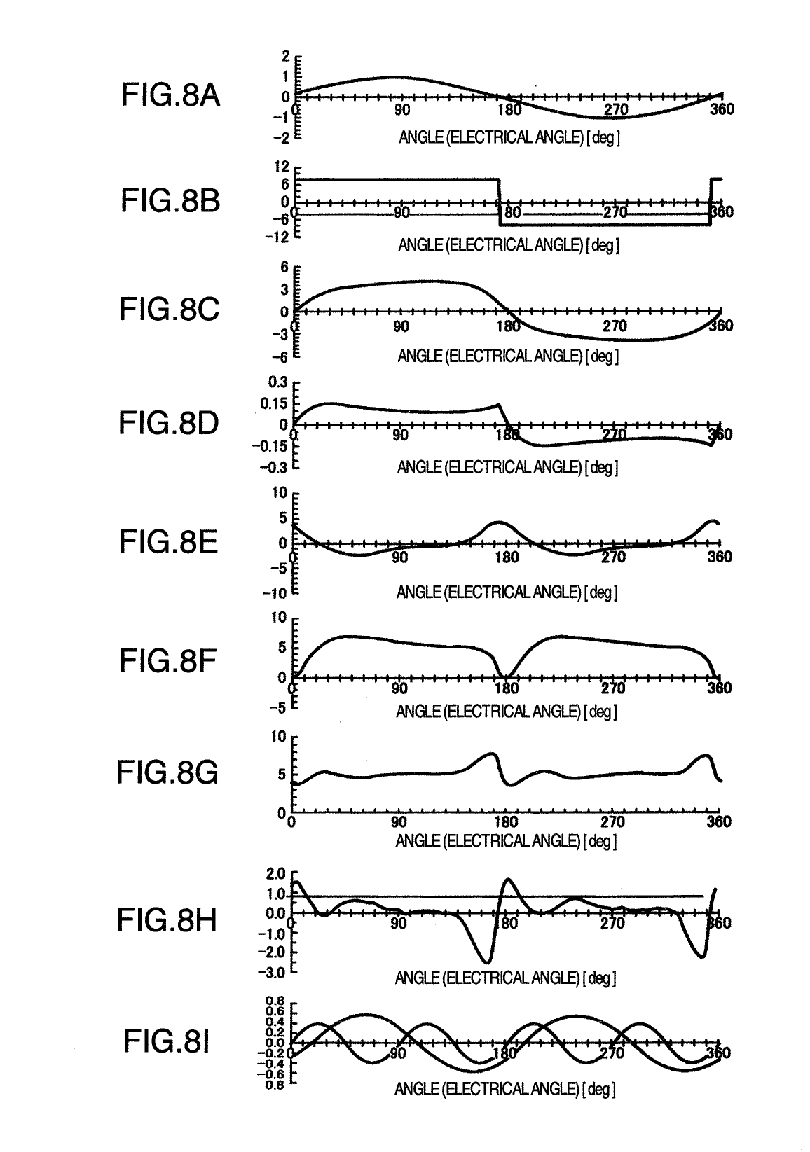

FIG. 7 shows details of a principal part in the embodiment according to the present invention. FIGS. 8A to 8I show operation explanation diagrams of the embodiment according to the present invention.

The embodiment differs from the foregoing embodiments only in the pulsating torque calculation unit 116.

Pulsating torque shown in FIG. 8H can be calculated.

In the present embodiment, the pulsating torque is decomposed into frequency components and control is exercised every frequency component. Herein, a method for reducing the torque ripple at two frequencies, for example, at a frequency that is twice the fundamental wave in the electrical frequency and a frequency that is four times the fundamental wave will be described.

Basically, the ripple in the total torque can be reduced by calculating the phase and magnitude at each of two frequency components in the pulsating torque and exercising proportional integral control at each of the frequencies.

Hereafter, a concrete embodiment and operation will be described with reference to the drawings.

In the configuration shown in FIG. 7, the pulsating torque calculation unit 116 includes an output torque calculation unit 117 for calculating an output torque on the basis of the output of the current sensor 118, the output of the angle conversion unit 112, the cogging torque information 113 and the induced voltage information 114, and a pulsating torque operation unit 20 for calculating average torque of the output torque from the output torque calculation unit 17 and pulsating torque from an output of the output torque calculation unit 117. This pulsating torque can be decomposed as shown in FIG. 8I. A first calculation unit 21 for phase and magnitude of a component corresponding to twice the fundamental frequency can calculate its phase and magnitude of the pulsating torque by using the Fourier integral. A first correction signal generation unit 22 for a component corresponding to twice the fundamental wave exercises control with the goal of the component corresponding to twice the fundamental wave set to 0 and thereby generates correction torque for the component corresponding to twice the fundamental wave of the calculated pulsating torque. As a result, it is possible to selectively suppress the ripple of the component corresponding to twice the fundamental wave of the pulsating torque.

As for the component corresponding to four times the fundamental frequency of the pulsating torque as well, a second calculation unit 23 for phase and magnitude of a component corresponding to four times the fundamental frequency can calculate its phase and magnitude by using the Fourier integral in the same way. In addition, a second correction signal generation unit 24 for a component corresponding to four times the fundamental wave exercises control with the goal of the component corresponding to four times the fundamental wave set to 0 and thereby generates correction torque for the component corresponding to four times the fundamental wave of the calculated pulsating torque. In addition, a correction signal synthesis unit 25 exercises control. As a result, it is possible to selectively suppress the torque ripple of the two frequency components.

FIG. 8I shows torques of the components respectively corresponding to twice and four time the fundamental frequency obtained by analyzing the pulsating torque shown in FIG. 8H. Output components of the calculation unit for phase and magnitude of a component corresponding to twice the fundamental frequency 21 and the calculation unit for phase and magnitude of a component corresponding to four times the fundamental frequency 23 are shown in FIG. 8H. As a result, it is possible to reduce the torque ripple by generating effective correction signals.

In general, vibration and noise generated in the electromotive pump and electromotive fan are based on factors having relations of integer times in electrical angle, in many cases. Therefore, it is considered that the present scheme capable of reducing the factors every frequency is effective.

It should be further understood by those skilled in the art that although the foregoing description has been made on embodiments of the invention, the invention is not limited thereto and various changes and modifications may be made without departing from the spirit of the invention and the scope of the appended claims.

1. A single-phase position sensorless permanent magnet motor control apparatus for controlling a power converter which drives a single-phase permanent magnet motor, the single-phase position sensorless permanent magnet control apparatus comprising:
a motor current measuring unit;
a terminal voltage measuring unit;
a correction unit for correcting an impedance drop in motor constants; and
a calculation unit for finding an induced voltage to be obtained by control,
wherein a polarity of a terminal voltage is determined on the basis of a value of the found induced voltage.

2. The single-phase position sensorless permanent magnet motor control apparatus according to claim 1, wherein at time of start, a current is let flow through the single-phase permanent magnet motor to determine a direction of the terminal voltage.

3. A single-phase position sensorless permanent magnet motor control apparatus for controlling a power converter which drives a single-phase permanent magnet motor, the single-phase position sensorless permanent magnet control apparatus comprising:
a motor current measuring unit;
a terminal voltage measuring unit;
a correction unit for correcting an impedance drop in motor constants; and
a calculation unit for finding an induced voltage to be obtained by control,
wherein an energizing current is continuously controlled on the basis of a value of the found induced voltage.

4. A single-phase position sensorless permanent magnet motor control apparatus for controlling a power converter which drives a single-phase permanent magnet motor, the single-phase position sensorless permanent magnet control apparatus comprising:
a motor current measuring unit;
a terminal voltage measuring unit;
a correction unit for correcting an impedance drop in motor constants; and
a calculation unit for finding an induced voltage to be obtained by control,
wherein changeover between positive and negative parts of the terminal voltage is conducted at a position of a high absolute value of the found induced voltage.

5. A fan and pump comprising the single-phase position sensorless permanent magnet motor control apparatus according to claim 1.

6. A single-phase permanent magnet motor control apparatus for controlling a power converter to drive a single-phase permanent magnet motor which includes a rotor having permanent magnets and a stator having single-phase windings and which generates cogging torque by magnetic action between the rotor and the stator, wherein
the single-phase permanent magnet motor control apparatus comprises cogging torque and induced voltage waveform information of the single-phase permanent magnet motor.

7. The single-phase permanent magnet motor control apparatus according to claim 6, wherein a shape of a gap face of a stator core of the single-phase permanent magnet motor is made different according to a rotation direction.

8. The single-phase permanent magnet motor control apparatus according to claim 6, wherein the single-phase permanent magnet motor control apparatus has a function of detecting a temperature and a function of correcting the cogging torque and induced voltage information according to the detected temperature.

9. The single-phase permanent magnet motor control apparatus according to claim 6, wherein output torque and output power are calculated and subjected to frequency analysis, and control is exercised every frequency.

10. The single-phase permanent magnet motor control apparatus according to claim 6, wherein a circumference direction is divided into a plurality of sections and control is exercised every section.

11. The single-phase permanent magnet motor control apparatus according to claim 6, wherein the control does not comprise integral control.

12. A fan and pump comprising the single-phase position sensorless permanent magnet motor control apparatus according to claim 6.
